(19) United States
(12) Patent Application Publication
(10) Pub. No.: US 2009/0284009 A1
(43) Pub. Date: Nov. 19, 2009

(54) SYSTEM FOR FLUID TUBING CONNECTIONS

(76) Inventors: GERARD E. TOOHEY, ESSEX FELLS, NJ (US); JOHN MILES CHIZACKY, POMPTON PLAINS, NJ (US)

Correspondence Address: VALDIVIA-LAFEIR LAW, 12 GLEN OAK DRIVE, MIDDLETOWN, NJ, 07748, US

(21) Appl. No.: 12/407,761

(22) Filed: Mar. 19, 2009

Related U.S. Application Data
(60) Provisional application No. 61/037,976, filed on Mar. 19, 2008.

(51) Int. Cl. F16L 19/06

(52) U.S. Cl. 285/343

(57) ABSTRACT

An embodiment of the present invention includes a fluid tubing connection system comprising a nut component, an anti-seize ring component, and a ferrule component. In assembly, the nut component slides onto an exterior of the tubing, followed by the ring component. The ferrule component is then coupled to an end of the tubing and has an interior diameter that matches an interior fluid diameter of the tubing. When connected to a fluid device, the anti-seize ring component isolates the tubing from any rotational motion of the nut component, which prevents damage of the tubing caused by seizing or twisting. Further, the connection system conforms the tubing such that the internal fluid path is continuous with substantially zero unswept volume.

### CROSS-REFERENCE TO OTHER APPLICATIONS

This application claims the benefit of our co-pending United States provisional patent application entitled “System for Tubing Connections” filed Mar. 19, 2008 and assigned Ser. No. 61/037,976, which is incorporated by reference herein.

### BACKGROUND OF THE INVENTION

1. Field of the Invention

Embodiments of the present invention generally relate to fluid device connectors, and more specifically, an anti-seizing fluid connection system for connecting fluid tubing to a fluid receptacle or device.

2. Description of the Related Art

Fluid control and instrumentation devices commonly require connections to other system components such as supply reservoirs, actuation devices, other demand loads and supplies. The fluid is generally carried by a tubing of some type. These connections require initial assembly; and often frequent disassembly and reassembly after which each connection must maintain an initial leak proof integrity without the use of tapes, pastes, or any other material applied to the connection components. The connections must be made expeditiously and without compromising the tubing or connector components, preferably with commonly available tools.

The connection hardware of common state of the art systems commonly use compression components termed ferrules and nuts that seize the connected tubing radially causing the ferrule, nut, and tube to act as one. Compression ferrules work by applying a radial force to the outside of the system tubing. The compression force must be great enough to preclude a leak path between the ferrule and tubing and also between the ferrule and internal nut surfaces. A drawback associated with this system is the difficulty in assembly and disassembling these components because the nut-ferrule-tubing elements tend to rotate together, thereby allowing the tubing to twist during assembly or disassembly and be prone to damage. More specifically, the resultant radial compression forces the ferrule into the tubing material, causing deformation of the tubing and rendering it vulnerable to leaking upon disassembly and reassembly.

An additional drawback associated with the ferrule-nut type of connection system, when used with plastic tubing, is compression ferrules seal by exerting radial forces sufficient to collapse and reduce the inside diameter of the tubing. Although this inside diameter reduction may be small relative to the nominal inside diameter of the original uncollapsed tubing, such a reduction can be a factor in tubing integrity and in subsequent analytical work. Further, when the ferrule-nut system is disassembled and then reassembled, the nut typically requires an increased assembly torque to create a leak-proof seal compared to that required for the initial connection. This increased torque translates into an increased radial compressive force on the ferrule/tube interface, which causes additional intrusion of the ferrule into the plastic tubing. After several disassemblies and reassemblies, the ferrule-nut system can fail completely, requiring frequent replacement. Tubing made of soft materials, for example, non-metals, is particularly vulnerable to diameter reduction and collapse.

For connections in laboratory instrumentation devices, it is often required for the connection assembly to have little to no unswept volume in the fluid delivery path. Unswept volume is a quantity of fluid material remaining in fluid delivery connection system after a fluid delivery event. Unswept volume can cause problems when different fluids or different concentrations of similar fluids are delivered through a common connection assembly. Common valves and other known fluid control devices typically use threaded ports for connection. However, the typical threaded port inherently is associated with large unswept volume. Thus, minimum unswept volume is especially critical in analytical equipment. Additionally, such instrumentation devices often employ plastic tubing with a small outside diameter, on the order of ⅛ inch or smaller, which is particularly sensitive to seizing, twisting and possible damage as previously discussed.

Thus, there exists a need in the art for a tubing connection system with minimal seizing and twisting, and further, causing a minimal unswept volume effect.

### SUMMARY OF THE INVENTION

An embodiment of the present invention includes a fluid tubing connection system comprising a nut component, an anti-seize ring component, and a ferrule component. In assembly, the nut component slides onto an exterior of the tubing, followed by the ring component. The ferrule component is then coupled to an end of the tubing, where the end may be expanded and a distal end of the ferrule component is inserted. Alternately, the distal end may be coupled directly to the tubing end by splicing or fusion. The ferrule component has an interior diameter that matches the interior fluid path diameter of the tubing.

The nut component has a proximate end that is preferably threaded for entry into the fluid delivery port of the connecting fluid device. As this proximate end is screwed into the port, the anti-seize ring component is pressed against the tubing end, which exerts a pressure to allow the tubing to conform to the geometry of the ferrule component. This creates a virtually seamless fluid delivery path from the tubing through the ferrule component and into the fluid device, thereby creating a virtually zero unswept volume effect.

Simultaneously, the ring component virtually isolates the tubing from any seizing or twisting caused by the turning of the nut component, which has an interior diameter slightly larger than an exterior diameter of the tubing. Thus, no damage is caused to the tubing during this assembly. When disassembled, the anti-seize ring component again isolates the tubing from the rotational movement of the nut component, thus allowing the tubing with this connection system to be used repeatedly and efficiently.

### BRIEF DESCRIPTION OF THE DRAWINGS

The teachings of the present invention can be readily understood by considering the following detailed description in conjunction with the accompanying drawings, in which:

FIG. 1 depicts a fluid tubing connection system, in accordance with an embodiment of the present invention.

### DETAILED DESCRIPTION

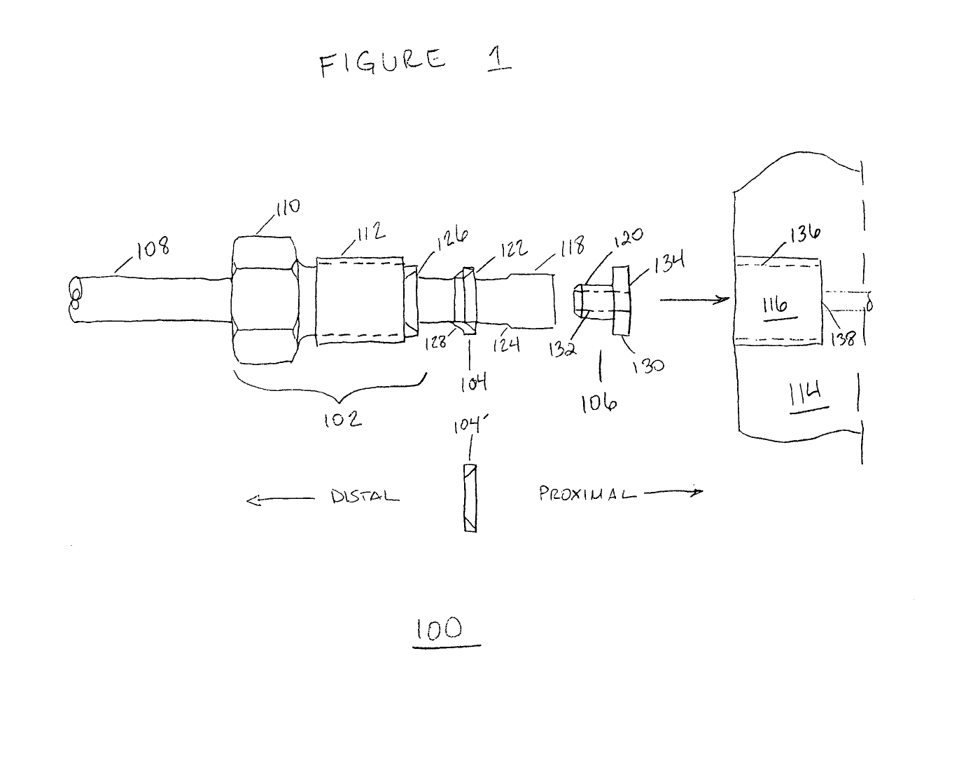

An embodiment of the present invention includes a tubing connection system 100 as shown in FIG. 1. System 100 includes a nut component 102, an anti-seize ring component 104, and a ferrule component 106 that combine together to slide over a fluid delivery tubing 108 and function to connect tubing 108 to a fluid device 114 without seizing or damaging the tubing during assembly, disassembly, or reassembly and achieves virtually zero unswept volume in a fluid delivery path between tubing 108 and fluid device 114. System 100 can be applied to any type of fluid tubing material such as plastic, thermoplastic, metal and the like. Further, system 100 can be made from any type of plastic, thermoplastic, rigid or semi-rigid material.

Nut component 102 has a distal end 110 that is polygonal in shape to allow the use of conventional tools for assembly, such as a wrench. The distal end 110 may be substituted with other configurations, such as a knurled configuration, that do not require the use of common tools for assembly. Nut component 102 also has a proximate end 112 that, preferably, is threaded externally for connection to a port 116 in device 114 that is typically threaded, however, proximate end 112 of nut component 102 also may be configured without external threading for proper connection to a non-threaded port.

An axial opening runs through the length of nut component 102 to fit and slide over tubing 108. The lengthwise axial opening has a diameter that is slightly larger than an outside diameter of tubing 108 to allow for nut component 102 to slide easily over tubing 108 while providing an efficient connection when coupled with ring component 104 and ferrule component 106.

An anti-seize ring component 104 is displaced between nut component 102 and an end 118 of connection tubing 108. Ring component 104 has a distal end 128 to engage a proximate end face 126 of nut component 102 and a proximate end 122 to engage tubing end 118. To create a secure assembly, distal end 128 can have a guided design, such as an angular geometry, that substantially matches a geometry of proximate end face 126, such as, for example, a concave or angular geometry. Additionally, proximate end 122 can be designed to mate with a back end 124 of tubing end 118 for the instance where tubing end 118 is expanded. Alternately, system 100 may include anti-seize ring component 104′ having a flat, unguided design to couple with a proximate end face of nut component 102 that has no angular or concave geometry. It is noted, however, that while at least these two configurations are encompassed within the scope of the invention, the guided angular geometry of distal end 128 mating with matching angular or concave geometry of proximate end face 126 provides a better concentric assembly of system 100.

Ferrule component 106 includes a distal end 120 and a proximate end 130. In assembly, ferrule component 106 is inserted into tubing end 118. As mentioned previously, tubing end 118 may be expanded prior to receiving distal end 120 in order to provide a secure fit with ferrule component 106. Thus, distal end 120 has an outside diameter that substantially matches an inside diameter of expanded end 118, and an inside diameter, shown by dashed lines 132, that substantially matches the inside diameter of tubing 108 prior to expansion to create a seamless fluid flow into fluid device 114.

Alternately, tubing end 118 need not be expanded and distal end 120 of ferrule component 106 is designed to couple to tubing end such that the interior diameter of tubing 108 and the interior diameter 132 of component 106 match upon the coupling to still create the seamless fluid flow. An example of this instance applies where tubing end 118 has a v-shaped end with a concave, angular geometry and distal end 120 has a matching convex v-shape to couple virtually seamlessly with the v-shaped tubing end 118. However, it is noted that expanding the tubing end 118 is preferred from an overall manufacturing standpoint.

In application, nut component 102 slides onto tubing 108, followed by ring component 104. Tubing end 118 is then expanded and distal end 120 of ferrule component 106 is inserted into expanded end 118. This initial assembly is then inserted into fluid device port 116 and the threads on proximal end 112 of nut component 102 mate with threads 136 in port 116. As assembly occurs, nut component 102 pushes against ring component 104 creating a pressure that causes tubing 108 to conform to the geometry of distal end 120 thereby making the internal fluid path continuous with approximately zero unswept volume. This is significantly less than what occurs with current conventional connection systems. Additionally, distal end 120 can have a mating geometry that substantially matches an interior angle on the inside of expanded end 118 that is produced during expansion, for a secure fit.

Anti-seize ring component 104, in conjunction with components 102 and 106, substantially isolates any rotational motion of nut component 102 during assembly, disassembly and reassembly, from being transmitted to tubing 108, thereby preventing nut component 102 from seizing and twisting tubing 108. Unlike conventional connection systems, the inventive system 100 is not affected by any softness of the tubing material or pliability of the tubing material because the inserted distal end 120 of ferrule component 106 supports tubing 108 from the inside while ring component 104, which slides and moves to meet up with ferrule component 106 protects the exterior of tubing 108 from rotational motion. Thus, system 100 provides an improved fluid tubing connection without damaging the tubing.

An aspect of this embodiment includes ferrule component 106 having a geometry on a proximal face 134 such that an initial contact pressure is applied between this geometry and a fluid path geometry of device port 116. This localized pressure creates a seal between ferrule component 106 and fluid device 114 at a fluid path entry point 138, thus creating a substantially continuous path for fluid transfer with virtually no unswept volume. Inventive system 100 thereby allows for initial and subsequent disassembly and reassembly operations without difficulty, while maintaining the leak proof integrity of the connection.

Although various embodiments which incorporate the teachings of the present invention have been shown and described in detail herein, those skilled in the art can readily devise many other varied embodiments that still incorporate these teachings.

I claim:

1. A system for connecting fluid delivery tubing to a fluid device that creates an internal fluid path substantially continuous with approximately zero unswept volume and minimizes seizing and damage of the delivery tubing during assembly and disassembly in addition to use and re-use, comprising:
a nut component having a distal end, a proximate end, and an axial opening running lengthwise through the nut component, for running the fluid delivery tubing through;
a ring component for connecting the nut component to an end portion of the delivery tubing, wherein the ring component does not seize nor twist the tubing during assembly, disassembly, or reassembly: and
a ferrule component for coupling the delivery tubing to the fluid device.

2. The system of claim 1, wherein the lengthwise axial opening of the nut component has a diameter that is slightly larger than an outside diameter of the delivery tubing.

3. The system of claim 1, wherein the proximate end of the nut component is externally threaded for mating with an interior geometry of a port of the fluid device.

4. The system of claim 1, wherein the distal end of the nut component has a polygonal shape for assembly and disassembly with conventional mechanical tools.

5. The system of claim 1, wherein the distal end of the nut component has a knurled shape.

6. The system of claim 1, wherein a distal end of the ring component has a mating geometry that approximately matches a geometry of the proximate end of the nut component.

7. The system of claim 6, wherein the geometry of the proximate end of the nut component is angular.

8. The system of claim 6, wherein the geometry of the proximate end of the nut component is concave.

9. The system of claim 1, wherein the ring component has a flat configuration.

10. The system of claim 1, wherein the ferrule component has an internal diameter that substantially matches an internal diameter of the delivery tubing.

11. The system of claim 10, wherein a distal end of the ferrule component is configured for insertion into the end portion of the delivery tubing such that a connection between the internal diameter of the ferrule component and the internal diameter of the tubing is virtually seamless, thereby creating a substantially continuous internal fluid path.

12. The system of claim 11, wherein the end portion of the delivery tubing is expanded prior to insertion of the distal end of the ferrule component.

13. The system of claim 12, wherein a proximate face of the ring component has a geometry to substantially match a back end of the expanded end portion of the delivery tubing.

14. The system of claim 13, wherein the geometry of the proximate face of the ring component is concave.

15. The system of claim 13, wherein the geometry of the proximate face of the ring component is angular.

16. The system of claim 10, wherein the distal end of the ferrule component is configured to couple directly to the end portion of the delivery tubing such that a connection between the internal diameter of the ferrule component and the internal diameter of the tubing is virtually seamless, thereby creating a substantially continuous internal fluid path.

17. The system of claim 1, wherein a proximate face of the ferrule has a geometry for optimizing coupling to the fluid device to create a substantially continuous internal fluid path.

18. The system of claim 17, wherein the geometry of the proximate face is a convex central geometry.

19. The system of claim 1 wherein the nut component, ring component, and the ferrule component are each made from a rigid or semi-rigid material.
